(19) United States
(12) Patent Application Publication
(10) Pub. No.: US 2006/0023917 A1
(43) Pub. Date: Feb. 2, 2006

(54) Object detection method for vehicles

(75) Inventors: Juergen Dickmann, Ulm (DE); Michael Skutek, Ulm (DE); Rajan Prasanna, Lakshmi Nagar (IN)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/173,578

(22) Filed: Jul. 1, 2005

(30) Foreign Application Priority Data
Jul. 1, 2004 (DE) 10 2004 032 118.3

(51) Int. Cl. G06K 9/00

(52) U.S. Cl. 382/104

(57) ABSTRACT

An object detection method for vehicles, which employs at least one sensor S for cyclically detecting a vehicle's surroundings whose measured values M are projected into a freely definable grid G and are combinable into grid-based segments that can be assigned to identified objects O, and, in accordance with which, tracks for these objects O are ascertained which can be used for controlling vehicle functions. The cells Z of the grid G are designed to have incremental dimensions that differ in their incremental dimensions in the radial and/or circumferential direction in such a way that a functionally optimized object resolution is achieved.

Priority is claimed to German Patent Application No. DE 10 2004 032 118.3, filed on Jul. 1, 2004, the entire disclosure of which is incorporated by reference herein.

The present invention relates to an object detection method for vehicles, which employs at least one sensor for cyclically detecting a vehicle's surroundings whose measured values are projected into a freely definable grid and are combinable into grid-based segments that can be assigned to identified objects, and, in accordance with which, tracks for these objects are ascertained which can be used for controlling vehicle functions.

### BACKGROUND

Here, the concept of segmentation implies combining a plurality of measuring points from the raw data of a laser scanner, for example, on the basis of specific criteria. The aim of the segmentation process is to subdivide the raw data into segments which can be allocated to real objects in the sensor's visual detection range. Problems can arise due to potential errors during the segmentation process or also due to erroneous raw data, such as: (1) one segment including a plurality of real objects; (2) one object being subdivided into different segments; (3) no segment being assigned to a real object and, consequently, it no longer being possible for the object to exist for subsequent signal-processing steps; and (4) a segment also being able to be formed which, objectively, is not to be assigned to any real object.

While the first point mostly affects the accuracy and the degree of complexity of the tracking algorithm, the second point can, above all, result in difficulty when classifying the real objects in the sensor's visual range. This is explained in greater detail in the relevant sections in the following. The two last points directly affect the specific application, i.e., the last stage of the signal processing.

To achieve a most effective possible signal processing in subsequent stages and, accordingly, to undertake the necessary steps to minimize the errors and thus the outlay required to rectify such errors in subsequent signal processing steps, the following aspects should be considered in the segmentation process.

When filtering the raw data, it is not only very important to uniquely assign raw data (groups) to real objects, but it is also very important to prevent artificial (or apparent) segments, which lead to artificial (or apparent) objects. This is achieved by filtering out the measured values that have resulted from measuring errors and not from correct determination of distance between the sensor and the object.

Prediction and innovation constitute part of the tracking process. In dependence upon the position, moving direction, sampling rate of the sensory system, i.e., clock rate of the tracking algorithm, and the velocity of the object at instant t-1, a prediction is made about the position of the object at instant t and combined with the measurement at this instant to form a new position. In this connection, however, the position is related to one point. The quality of the positional estimation can be influenced by forming a reference point. The relative motion of the objects changes their contour and influences the determination of the reference point.

This influence must be minimized in order to avoid generating any artificial (or apparent) motion of the objects.

The association process as part of the tracking determines the allocation of the segments to already established objects. It becomes difficult to allocate a segment to an object, in particular, at high velocities, low sampling rates of the sensor, and when working with a multiplicity of objects. This is true, in particular, of objects for which a reliable prediction is not yet available due to a lack of history. Some of the preferably most meaningful features extracted from the segments can be helpful when allocating segments to already existing objects.

If a subsequent classification is made, besides the observation of the sequence of motion of objects, the shape or contour is also of particular significance for the quality of the classification. Here, just as in the case of the association process, a few meaningful features of the segments are useful.

An obvious approach for forming segments is to search for interrelated points on the basis of geometric distance criteria. In this case, the distance measurements are compiled with the aid of search areas which are placed over the measurements in the φ direction in a step-by-step process.

The attached FIG. 1 (related art) shows an elliptical search area for the segmentation process. As long as subsequent measurements lie within the search area, they are to be assigned to the current segment. If the subsequent measurements lie outside of the area, a new segment begins.

The search areas can have rectangular, circular or elliptical shapes, for example. In this connection, the criterion for the quality of a search area is the most accurate possible mapping of the geometric properties of the measuring procedure and of the physical properties of the sensor. In the case of the laser scanner, it holds for the distance between two adjacent measuring points that:
d_{PQ}=ƒ(γ,r_{P},r_{Q}). (1)

The distance between the measured values in points P und Q depends on the angular resolution γ and on the distances rₚ and r_{Q} between the sensor and points P and Q, respectively, and can be illustrated based on a right-angled example:

$$\begin{matrix}{r}_{P} = \frac{y}{sin {α}_{P}} & ( 2 ) \\ {r}_{Q} = \frac{y}{sin {α}_{Q}} & ( 3 ) \\ {x}_{P} = \frac{y}{tan {α}_{P}} & ( 4 ) \\ {x}_{Q} = \frac{y}{tan {α}_{Q}} & ( 5 ) \\ {d}_{PQ} = {x}_{Q} - {x}_{P} & ( 6 ) \\ {d}_{PQ} = \frac{y}{tan {α}_{Q}} - \frac{y}{tan {α}_{P}} & ( 7 ) \\ {d}_{PQ} = \sqrt{{r}_{Q}^{2} - {y}^{2}} - \sqrt{{r}_{P}^{2} - {y}^{2}} & ( 8 ) \\ {d}_{PQ} = \sqrt{{( \frac{y}{sin {α}_{Q}} )}^{2} - {y}^{2} - \sqrt{{( \frac{y}{sin {α}_{P}} )}^{2} - {y}^{2}}} . & ( 9 )\end{matrix}$$

At this point, a minimal incident radiation angle α is assumed, starting at which the total reflection of the emitted laser radiation occurs at a typical object. This angle determines the maximum distance between two adjacent measuring points of an object. It is assumed in this case that both points lie on a straight line:

$${d}_{max} = {lim}_{r \to max , y \to min} \sqrt{{r}_{Q}^{2} - {y}^{2}} - \sqrt{{r}_{P}^{2} - {y}^{2}} \qquad ( 10 )$$

Using the scaling factors, the search area dimensions of a circle are expressed as:
r_{K}=S_{K(r)}·dₘₐₓ (11)
r_{K}=Sₖ₍ᵣ₎·(\sqrt{r_{Q(max)}²−yₘᵢₙ²}−\sqrt{r_{P(max)}²−yₘᵢₙ²}) (12)

It may be that the circle as a search area is thus dynamically adaptable for increasing r, but a closer adaptation of the search area to the dependency on α is not possible. The search starting from point rₚ is carried out in all directions using the same criterion for distance. The use of a rectangular or elliptical search area makes it possible to include the dependency of the distance dₘₐₓ on α. It holds for the ellipse then that:

$${r}_{E} = \frac{{x}^{′ 2}}{{a}^{2}} + \frac{{y}^{′ 2}}{{b}^{2}} \qquad ( 13 )$$

The angular resolution γ of the sensor being expressed as:

$$\begin{matrix}a = 2 \cdot r \cdot sin \frac{y}{2} & ( 14 ) \\ a = 2 \cdot ( \sqrt{{r}_{Q ( max )}^{2} - {y}_{min}^{2}} - \sqrt{{r}_{P ( max )}^{2} - {y}_{min}^{2}} ) & ( 15 )\end{matrix}$$

Thus, the dependency of the distance between two points on the incident radiation angle α is given between the limiting cases by a for rₚ=r_{Q} and b for α→min in the form of an ellipse:

$$\begin{matrix}{d}_{max {x}^{′}} = {S}_{k ( {x}^{′} )} \cdot a & ( 16 ) \\ {d}_{max {y}^{′}} = {S}_{k ( {y}^{′} )} \cdot b & ( 17 ) \\ r = \frac{{x}^{′ 2}}{{( {S}_{K ( {x}^{′} )} \cdot a )}^{2}} + \frac{{y}^{′ 2}}{{( {S}_{K ( {y}^{′} )} \cdot b )}^{2}} & ( 18 )\end{matrix}$$

It should also be noted in this context that, typically, it holds for the minimally possible incident radiation angle that:
αₘᵢₙ>0° (19)

This still leads to an additional error when defining b since, ultimately, b in the ellipse lies in α=0. Typically, however, this error is negligible for Sₖ>1 and small αₘᵢₙ.

For the rectangle mapping of the search area, equations 14 and 15 hold for the analog calculation of the dimensions. When an ellipse or rectangle is used, the search areas are to be rotated in accordance with the current scanning angle, as can likewise be inferred from FIG. 1.

However, the adaptation of the search area to various r in accordance with equations 12 and 18 presupposes the selection of a constant value for yₘᵢₙ. It is expedient for yₘᵢₙ to be the distance starting at which the total reflection of the laser radiation occurs at a typical object (such as a vehicle) which is oriented in parallel to the y-axis, in the maximally detectable or required distance. In addition, the dynamic adaptation of the search area is practical only up to the distance in which the widening of the search area as a function of the angular resolution of the sensor just corresponds to the dimensions of an object to be detected.

However, this type of mutual allocation of various measuring points is only practical within one horizontal plane of the laser scanner. The measured values of different planes can absolutely yield different results for the same measuring angle, as a function of the vertical spread angle and the object dimensions for the same measuring angle. This complicates the process of combining the various planes. The possibilities for combining the various planes using this method would be, inter alia, as follows.

In the case of a separate segmentation and later allocation of the segments, the process of combining the measured values and assigning them to a real object is carried out on an individual basis for each horizontal plane. The segments of the various planes are subsequently combined, for example with the aid of a geometric distance criterion per averaging operation. However, the outlay for the segmentation process increases with the number of planes. In addition, this method does not maximize the potential for improving the sensor's detection power. For example, in some cases, the cumulative consideration of all planes within one search area—in contrast to a consideration of the individual planes—would signify the exceeding of a threshold value, as of which a simple noise filter considers a detection as being assured.
(A₁<S)(A₂<S)(A₃<S) (20)
(A₁+A₂+A₃)<S (21)

This can be remedied through the use of (weighted) filtering when combining the segments, but this further increases the requisite outlay. In connection with the problem described above, however, separate consideration of the planes can also lead to further subdivision of the various planes in the case that measured values are missing which may be available in other planes. All of these problems are solvable, but lead to a substantial (mostly heuristic) outlay for signal processing.

When the measured values of the various planes are combined in a logic operation via the reference plane, the basis of this logic instruction is the selection of a reference plane, starting from which additional points are sought in other planes and linked together. In this context, a (geometric) distance criterion is to be used. In this case, the system's detection capabilities are closely tied to a reference plane. Data that are not available in the reference plane or distances that are too great between the measured values of various planes can make objects invisible to the system.

When the measured values of the various planes are combined using (weighted) AND (OR) functions, the measured values of the individual planes are to be combined with one another using (weighted) logic operations and, only then, are they to be subsequently segmented. However, this functions only under the assumption that the same objects are detected in all planes. However, this assumption cannot be made for a vehicle's surroundings. For example, the situation can arise that the road surface is detected in the lower planes in response to heavy braking.

The problems described above, particularly those related to combining the various planes in a logic operation and the difficulties that are entailed of fully maximizing the potential to improve the detection capabilities, led to the development of a grid-based segmentation process.

In this context, the idea underlying the grid-based segmentation process is that the search areas for assigning measured values to one another are formed by the cells of a grid. The measured values of all planes are projected into this grid. On the basis of a filter criterion, the cell is tagged as occupied. A cluster algorithm, selected in accordance with the requirements, groups the cells that belong together. This information, projected back onto the measured values, then represents the segmentation of the raw data and simultaneous combining of the various planes, while taking into consideration the extent to which the various planes can be detected.

It may be that the problems which occur due to the use of the combinatorial algorithms mentioned in the previous section are eliminated here. However, the dependencies of the size of the search area on the distance r and the incident radiation angle α continue to apply analogously to equations 9, 12 and 15.

The U.S. Published Application 2001/0018640 A1, incorporated by reference herein, describes a grid-based method for detecting obstacles to facilitate the safe operation of self-controlled vehicles. It describes projecting three-dimensional coordinate values of a measuring point onto horizontal and vertical planes which are divided into cells of a segmentation grid. The cells are then tagged as occupied/unoccupied in a generally known manner, grouped on the basis of specific criteria, and this information is projected back onto the raw data in order to segment the same. Thus, various measuring planes are, in fact, coupled on the basis of the coordinate values. However, safe navigation of a vehicle requires recording the vehicle surroundings over a wide range, in the form of a histogram, so that the method is not suited for time-critical applications, such as safety systems (pre-crash systems) or driver assistance systems (proximity warning systems, adaptive speed control systems, electronic hitches). The mentioned systems require a very high detection performance with respect to quality, speed and reliability of resolution.

### SUMMARY OF THE INVENTION

An object of the present invention is to provide a simple and cost-effective method of the type mentioned at the outset, which will provide a detection performance that is improved over conventional methods.

The present invention provides an object detection method for vehicles, which employs at least one sensor (S) for cyclically detecting a vehicle's surroundings whose measured values (M) are projected into a freely definable grid and are combinable into grid-based segments that can be assigned to identified objects (O), and, in accordance with which, tracks for these objects (O) are ascertained which can be used for controlling vehicle functions. According to the method, the cells (Z) of the grid (G) are designed to have incremental dimensions that differ in the radial and/or circumferential direction in such a way that a functionally optimized object resolution is achieved.

In contrast to segmentation based merely on distance criteria, the use of a grid for segmenting and first filtering of the measured values constitutes a very general and adaptable approach, which greatly simplifies the process of combining the individual measuring planes in particular.

In view of the disadvantages discussed at the outset inherent in the process of combining the detection planes, the present invention starts out from the assumption that it is possible to increase the detection performance of an object detection method on the basis of a segmentation grid. This means, however, that the disadvantages associated with search area size likewise arise when working with rectangular, circular or elliptical search areas, i.e., the search areas are dependent on distance r and incident radiation angle α. Thus, a grid of this kind is not able to be flexibly adapted to the particular function or to the specific application.

Therefore, a distinguishing feature of the present invention is that the precise mapping of the grid is carried out in a freely definable manner in order to conform to the function-specific requirements. In this context, one must consider the boundary conditions which result, on the one hand, from the geometric characteristics of the measuring process and, on the other hand, from the dimensions of the anticipated objects. In particular, however, the requirements of the application determine the structure of the grid. Thus, for driver assistance systems, an increased resolution is more likely used in the far region and, for safety systems, an increased resolution is more likely used in the middle and the near regions. By suitably adapting the grid to the actual requirements of the application, the computational time is reduced and the resolution of the relevant detection zones is enhanced. The search areas, mapped by the cells of the grid, are only to be calculated or predefined once during the starting procedure, for example in tabular form, which also economizes on computational time. However, it is also possible for a dynamic adaptation to be made for each measuring cycle. A suitable algorithm is to be provided for calculating the grid.

In one advantageous embodiment, the incremental dimension of the grid cells increases at least over one partial region of the grid, with increasing radial distance from the sensor. This is useful wherever the geometric dimensions of the grid result in an especially high cell density, for example in the near region and into the middle region. As a result, the computational time is reduced given an adequate, functionally optimized resolution, for example for precrash detection.

One advantage is attained when the increase in the incremental dimensions (i.e. step sizes) of the grid cells is limited to its middle circumferential region. When applying the approach to the vehicle surroundings, it is beneficial to have a fixed grid spacing in the r direction for especially small r and for especially large r to allow for adaptation to real object sizes. In the middle portion, the incremental dimension should then increase in accordance with equation 9, to allow for adaptation to the geometric characteristics of the measuring method.

A further benefit is attained when the incremental dimension of the grid cells increases in the circumferential direction toward the lateral edges of the grid. In this way, signals which take up computational time and may not contribute to the application, are excluded. In this context, the angular resolution is adapted to the anticipated objects, while taking into account the angular resolution of the sensor, for example by using a lower resolution in the peripheral regions because of clutter (i.e. noise) caused by surrounding buildings and, above all, plants.

The incremental dimension of the grid cells preferably increases in a geometric mathematical sequence. Accordingly, the grid is calculated in a very simple and computational time-optimized manner as expressed by:
wₖ₊₁=wₖ·q (22)
where
w is the incremental dimension of the cell;
k is the increment; and
q is a fixed factor.

It is especially preferred for the incremental dimension of the grid cells to increase in an exponential mathematical sequence. Here as well, a very simple and computational time-optimized calculation of the grid is rendered possible as expressed by:
wₖ₊₁=wₖ^{q} (23)

Another advantageous embodiment provides for the measured values of sensors of a plurality of planes to be projected into the grid and segmented. This reduces the influence of measurement errors or measurement failures and enhances the accuracy and reliability of the method.

It is especially preferred that the incremental dimension of the grid cells increase to the greatest degree in the lateral peripheral regions of the grid, with increasing radial distance from the sensor. This makes it possible for a lower resolution to be used in the peripheral regions, in contrast to the grid interior, thereby excluding interference effects caused, for example, by peripheral buildings, without reducing the detection sensitivity in the grid interior.

The process of segmenting the measured values preferably involves an algorithm of the connected components labeling type. This algorithm is selected in accordance with the particular requirements. It groups the cells that belong together based on the pixel connectivity of the measuring points that fall in these cells. Thus, a conventional, computational time-optimized algorithm is available.

A filter criterion for identifying the occupancy state of each cell preferably includes the number of measuring points per cell. This criterion is easily defined and is therefore likewise computational time-optimized.

Due to cost considerations, the above described method is preferably implemented by using a laser scanner.

It is understood that the aforementioned features and those still to be described in the following are not limited to the the combinations indicated here. The scope of the present invention is defined only by the claims.

### BRIEF DESCRIPTION OF THE DRAWINGS

The present invention is explained in greater detail in the following on the basis of an exemplary embodiment, with reference to the attached drawings, in which:

FIG. 1 shows an elliptical search area for the segmentation process according to the related art; and

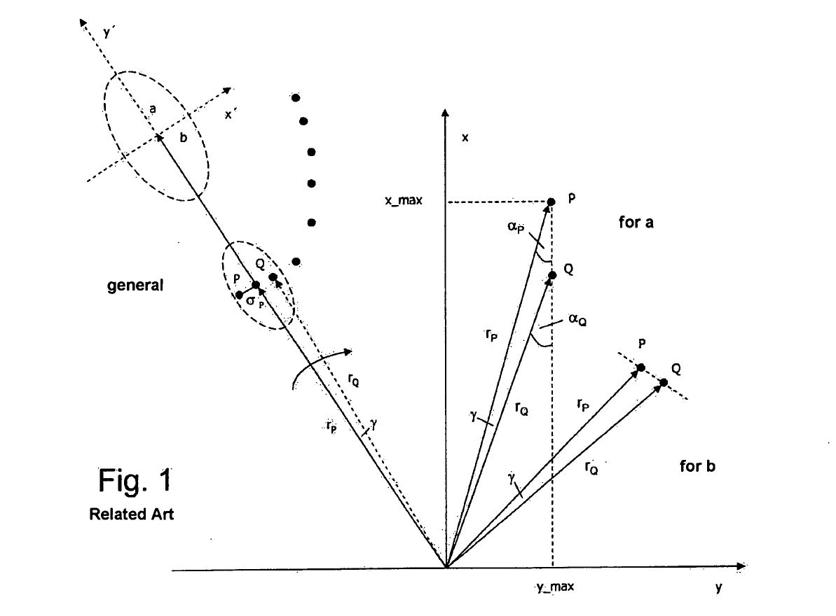

FIG. 2 shows an examplary embodiment of a search grid according to the present invention.

Equivalent parts or parts performing equivalent functions are denoted by the same reference numerals.

### DETAILED DESCRIPTION

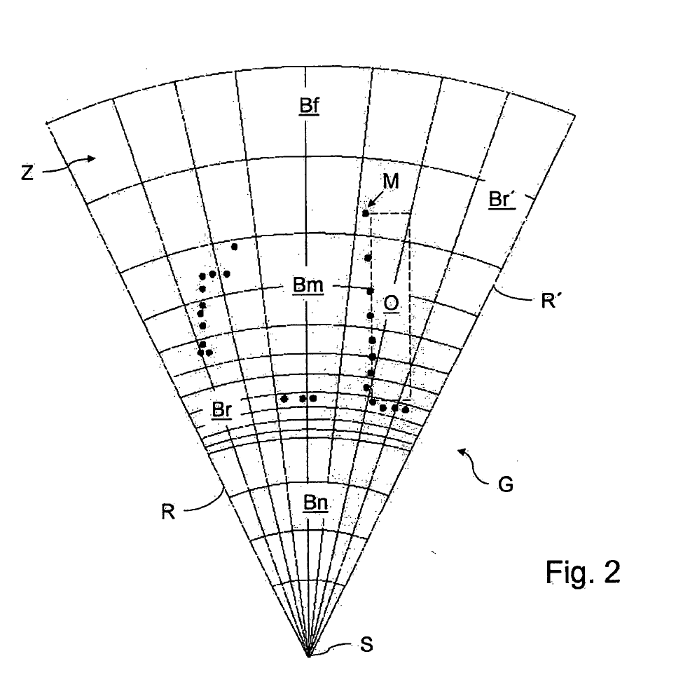

FIG. 2 shows exemplarily a grid G, whose near region Bn relative to a sensor S has an equidistant incremental dimension of cells Z. The incremental dimension of cells Z increases geometrically from a middle region Bm and into a far region Bf. Measured values of potential collision objects O (one of which is plotted exemplarily in grid G), recorded by sensor S, of all detection planes are projected into grid G, and, based on the number of measuring points per cell, it is ascertained which of cells Z is occupied. Cells that belong together are grouped by an appropriate cluster algorithm, and this result is projected onto the raw data in order to segment the same. Groups of raw data are formed which are assigned to an object and are used for determining tracks of the objects. In this context, each track represents a potential collision object, each actual destination being represented by at least one track. The tracks may be used, for example, for controlling safety systems, such as air bags, seat-belt pretensioners, etc.

The grid division described here is dimensioned for the above application case in that cells Z of grid G are spaced equidistantly in near region Bn and by incremental dimensions that increase—from a incremental dimension smaller than in region Bn—over regions Bm and Bf. Potential collision objects O are especially highly resolved in region Bm, in order to ensure an early (precrash) triggering of the safety systems before the near region. In this context, the computational time is limited for the most part to highly resolving region Bm. This exemplary embodiment does not provide for reducing the resolution in peripheral regions Br, Br′ of grid G toward edges R, R′, since there is no danger of possible peripheral buildings having an effect, due to the relatively narrow detection zone of sensor S.

By partitioning grid G under consideration of safety aspects in the exemplary manner described here, potential collision objects are able to be rapidly and precisely detected in a simple and cost-effective manner. The method is clearly improved over the known, conventional method with regard to the effectiveness and reliability of its detection capabilities.

What is claimed is:

1. A method of detecting an object in a vehicle surroundings for a vehicle, the method comprising:
cyclically detecting the vehicle's surroundings using at least one sensor so as to obtain a plurality of measured values;
providing a freely definable grid including a plurality of cells, each having incremental dimensions in a radial direction and a circumferential direction;
projecting the measured values into the grid;
combining the measured values into at least one grid-based segment;
assigning the grid-based segment at least one identified object;
ascertaining at least one track for the at least one identified object, the at least one track being useable for controlling a vehicle function; and
defining the incremental dimensions so as to differ from one another in at least one of the radial and the circumferential directions so as to functionally optimize a resolution of the object.

2. The method as recited in claim 1, wherein the defining of the incremental dimensions includes increasing the radial incremental dimensions of the cells in at least one region of the grid with increasing radial distance from the sensor.

3. The method as recited in claim 2, wherein the at least one region is limited to a middle circumferential region of the grid.

4. The method as recited in claim 1, wherein the defining of the incremental dimensions includes increasing the circumferential incremental dimensions of the cells in at least one region of the grid toward lateral edges of the grid.

5. The method as recited in claim 1, wherein the defining of the incremental dimensions includes increasing the incremental dimensions according to a geometric mathematical sequence.

6. The method as recited in claim 5, wherein the incremental dimensions are increased according to an exponential mathematical sequence.

7. The method as recited in claim 1, wherein the defining of the incremental dimensions includes increasing the incremental dimensions to a greatest degree at lateral peripheral regions of the grid with increasing radial distance from the sensor.

8. The method as recited in claim 1, wherein the projecting of the measured values includes projecting the measured values in a plurality of planes.

9. The method as recited in claim 1, wherein the segmenting is performed using an algorithm of the connected components labeling type.

10. The method as recited in claim 1, further comprising identifying an occupancy state of each cell using a filter critereon, wherein the filter criterion includes a number of measuring points per cell.

11. The method as recited in claim 1, wherein the sensor is a laser scanner.
